(19) United States
(12) Patent Application Publication
(10) Pub. No.: US 2008/0010892 A1
(43) Pub. Date: Jan. 17, 2008

(54) Field Decoy System

(76) Inventor: Patricia Kay Goebel, Boonsboro, MD (US)

Correspondence Address: WHITE-WELKER & WELKER, LLC, P.O. BOX 199, CLEAR SPRING, MD, 21722-0199, US

(21) Appl. No.: 11/734,990

(22) Filed: Apr. 13, 2007

Related U.S. Application Data
(63) Continuation-in-part of application No. 11/485,609, filed on Jul. 12, 2006, now abandoned.

(51) Int. Cl. A01M 31/06

(52) U.S. Cl. 43/2

(57) ABSTRACT

The Field Decoy System is a way of making motion in a hunter's field decoys without wind or with or without the use of motors to move the decoys. This motion system can move decoys even on windless days. A hunter needs just to pull the activation cord that is connected to all the decoy stakes. As the activation or activation cords are moved and stretch the bungee cord, the decoys rotate on the stake in a rotary motion. This rotary motion imitates the side-to-side wobbling movement of birds on the move, while feeding in a field. This style of motion will make wary game birds more apt to land by them believing that the decoys are real feeding birds.

### CROSS REFERENCE TO RELATED APPLICATIONS

This application is a continuation in part of U.S. patent application Ser. No. 11/485,609, entitled “Cupped-n-Committed Field Decoy System”, filed on Jul. 12, 2006, incorporated herein by reference.

### TECHNICAL FIELD OF THE INVENTION

The present invention relates generally to a field decoy system. More specifically, the present invention relates to a field decoy system with an apparatus for enabling motion in a hunter's field decoys without wind or with or without the use of motors to move the decoys.

### BACKGROUND OF THE INVENTION

Hunters have used decoys for many years to attract game to a hunter's location. Game can be wary of areas where the hunter's blind or location could be and the decoys help to make the game think it is safe to be in that area. Game can become what is referred to as “decoy shy”. When game birds become decoy shy they will not want to come into decoys that are not moving and appearing to be motionless tin soldiers. A motion decoy gives the appearance that the decoys are live birds moving around and feeding.

While many have tried to make very realistic decoys or limited motion systems for these decoys, only a few have made realistic motion systems. Most use wind to activate the motion and most wind systems can create unrealistic motion in high winds and undependable systems if the wind is not blowing, or not blowing hard enough. Some have made feeding motions but require the use of motors and electric power, which can be heavy to carry and are banned or moving toward being banned in some states. None have made a motion system that generates the side-to-side motion of a flock of birds walking or tipping forward in a feeding motion without the use of motors, electric power or wind.

The Feeding flock decoy assembly taught by U.S. Pat. No. 6,834,458 is similar to the Field Decoy System of the present invention in that it only creates a feeding motion of a decoy by the use of a string to supply motion. The Field Decoy System of the present invention can be used with or without a motorized unit to make the motion and is not limited to 6 decoys per actuation unit and moves the decoys in a side-to-side rotary motion also. The Feeding Flock decoy system only moves its decoys in a rocking forward vertical motion and does not also perform rotary movement of decoys.

The Animated Decoy taught by U.S. Pat. No. 2,547,286 has an assembly for moving ducks or geese in the water and uses pulley activation. This decoy motion setup is used the for water use of 4 decoys connected to the stake and assembly. This system is for water use and move said decoys in a circle.

The remote controlled animated decoy taught by U.S. Pat. No. 6,212,816 uses a similar horizontal motion as the Field Decoy System of the present invention, but uses a motor and a specific decoy that needs to be supplied to make the motion. It also oscillates and does not swing on horizontal axis like the Field Decoy System of the present invention. The Field Decoy System of the present invention can be used with or without a motor activation and uses the hunters existing or new decoys.

The tuff spike anchor system taught by U.S. Pat. Nos. 6,745,990, 6,402,115, and 6,719,939 is related to the lower half of the decoy motion stake for the design of the Field Decoy System of the present invention. The tuff spike anchor system is a great ground stake for landscaping and tent staking. This basic design was improved upon for use as a decoy stake. The original design was changed in length, the hole was slightly resized to accommodate a ½″ bar to drive and remove the stake into frozen ground. The hook for tent or string tie off was changed and repositioned to met different needs and the mating bar for the top sections of the decoy motion system to hold the decoys was added. The tuff spike lower half was used similarly so that the tuff spike could be used with a hammer to open frozen ground if needed.

### SUMMARY OF THE INVENTION

The decoy motion stake creates realistic motion in a hunter's decoys without the use of motors, wind or other expensive parts and fits a niche where states are banning the use of motorized decoy units or systems. Simply by pulling or stretching a decoy activation cord a hunter will be able to cause the decoy motion stakes that are supporting decoys to rotate or tip forward to simulate real birds feeding in a hunters decoys, so game birds do not act decoy shy. Since this motion system does not have to use motors, it enables this system to be light for a hunter to carry in and this system can move one or many decoys at a time. It also allows hunter to create their own motion where spinning wind decoys and motorized decoys have been banned.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an assembled side view of the motion stake and rotary motion top to turn shell and full body decoys of the present invention;

FIG. 2 is an assembled side view of the motion stake and rotary motion top to turn silhouette decoys of the present invention;

FIG. 3A is an assembled side view of the motion stake with the silhouette feeding top of the present invention;

FIG. 3B is an assembled front view of the motion stake with the silhouette feeding top of the present invention;

FIG. 4A is a perspective view of the rubber-fastening washer used to secure decoys in high winds to the decoy motion top of the present invention;

FIG. 4B is a side view of the rubber-fastening washer of the present invention;

FIG. 5 is a top view of decoy system deployed with eight decoy stakes for shell or full body decoys and two activation cords;

FIG. 6 is a side view of a shell decoy mounted on the securing pins of the decoy motion stake of the present invention;

FIG. 7 is a side view of a full body decoy mounted on the securing pins of the decoy motion stake of the present invention;

FIG. 8 is an expanded side view of the motion stake and rotary motion top to turn silhouette decoys of the present invention;

FIG. 9A is an expanded front view of the motion stake and silhouette feeding motion top to move silhouette decoys in a vertical feeding motion of the present invention;

FIG. 9B illustrates the silhouette decoy in the state it would be after the activation cord has moved and the decoy has rocked forward to appear that it was feeding;

FIG. 10A illustrates the side view of the silhouette feeder top of the present invention;

FIG. 10B is a cut away view that illustrates the side view of the silhouette feeder top of the present invention;

FIG. 11A is an expanded front view of the motion stake of the present invention and shell or full body feeding motion top to move shell or full body decoys in a vertical feeding motion;

FIG. 11B illustrates the shell or full body decoy of the present invention in the state it would be after the activation cord has moved and the decoy has rocked forward to appear that it was feeding;

FIG. 12A illustrates a side view of the shell or full body feeder top of the present invention;

FIG. 12B—is a cut away view illustrating a side view of the shell or full body feeder top of the present invention.

FIG. 13 is a side view of the motion stake and rotary motion top to turn “specific” full body decoys of the present invention; and

FIG. 14 illustrates a decoy mounted on the motion top which controls and rotates the decoy.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a Field Decoy System that is an apparatus for moving one or more decoys at the same time with the pulling or moving of an activation cord that runs through all of the decoy stakes connected to make the working system. The system is configurable by the hunter using the system to make movement in their decoys for better decoying of game.

The field decoy system is designed to simulate the side to side wobbling of birds as they walk or tipping forward motion as they feed in a field or other areas. As birds walk they tend to wobble side to side and move their head from side to side as their body carries them. This system simulates the natural motion of birds feeding in a field. Whether those birds are geese, ducks, doves, crows or turkeys and the only thing different in the system, would be the size of the stakes for the birds to be hunted and the decoys used.

The Field Decoy System uses an activation cord to create the movement of the decoys. This activation cord is sometimes referred to in hunting circles as a “jerk cord” and is used to supply motion to decoys in a hunting condition. The activation cord is connected to an end stake at the hunter's blind or location and then run to one or several decoy motion stakes. Once run through the stakes the activation cord is connected to a bungee cord and another end stake on the far side of the decoys from the hunter's blind or location. The bungee cord applies tension to the string while still allowing slack to be pulled into the cord by the hunter. When the hunter pulls the cord it will cause the decoy on the stake to rotate or tip forward and creates the movement as described above. Once the activation cord is released, the decoy stakes and attached decoys will rotate back to its original starting position and ready to be activated once again.

The Field Decoy System is designed to work with shell, full body and silhouette decoys that are altered by the hunter to work with the system. Altering of the shell decoys is as simple as drilling two holes at the decoy balance point that are ¾″ on center from each other. On most full body decoys the hunter may have to drill the same holes in the top and a larger hole in the bottom of the decoy. Some full body decoys already have a hole in the bottom that can be used when their feet assembly is removed. The “specific” decoy only needs a hole to be drilled 1″ from the center of the existing decoy support tube. The “specific” decoy rests and is supported by one decoy control rod 52 and is controlled and rotated the other decoy support bar 53.

Silhouette decoys will have two holes drilled into them that are ¾″ on center to support and control the decoys. The holes need to be near the base of the silhouette decoys so they can be attached to their motion tops 10. The holes allow the decoy to slide on to the motion top 10 and be rotated or tipped forward into a feeding motion depending on which motion top 10 is used.

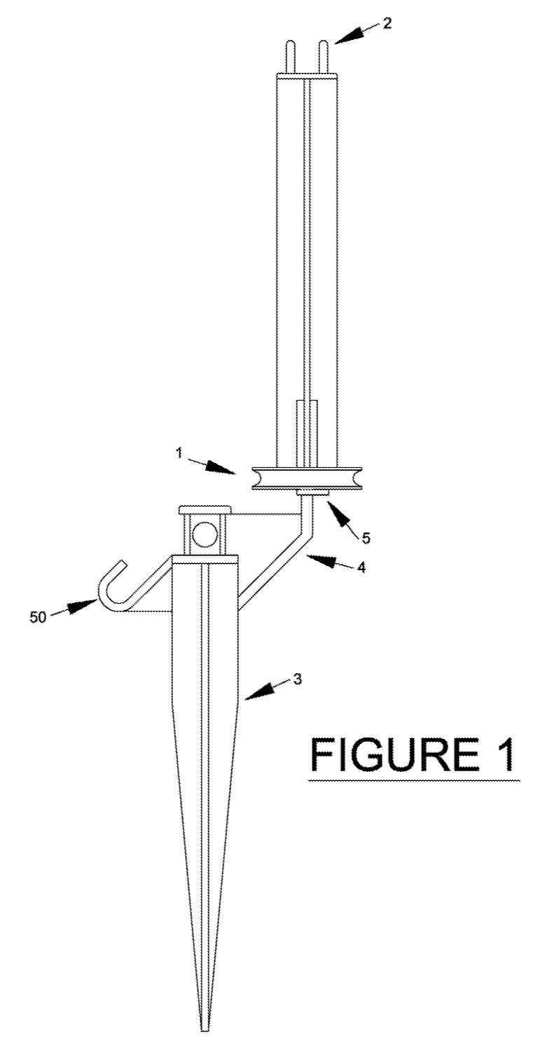

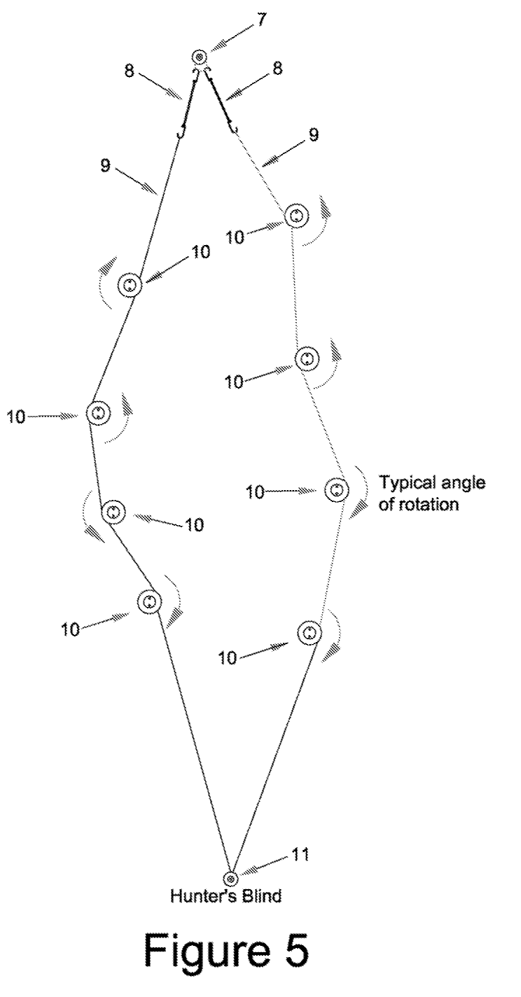

The complete assembled side view of the motion stake 3 and rotary motion top 10 to turn shell, full body decoys, and decoy stake, as shown in FIG. 1, is used to hold the various motion tops 10 in place on the decoy support bar 4. The decoy support bar 4 is shown and partially concealed in the motion top 10 as the motion top 10 rests on the stop washer 5. The pulley area 1 where the activation cord will cause the motion top 10 to rotate is shown here. The string hook 50 is used to tie off the activation cord and secure the bungee cords where end stakes are shown in FIG. 5.

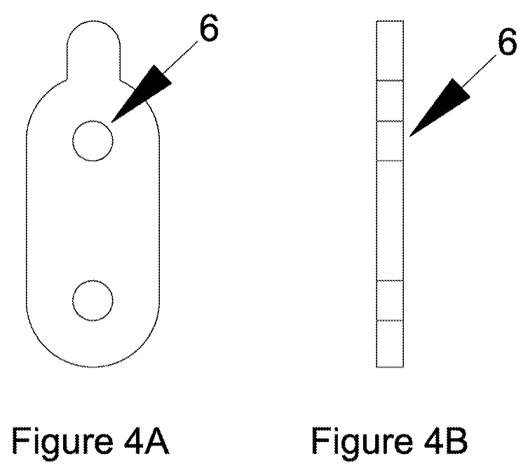

Once a motion top 10 is slide onto the decoy stake it rests on the stop washer 5 and they function as one unit for controlling decoys. The rubber-fastening washer, a shown in FIG. 4, is used to secure the shell or full body decoys to their stake over the pins 2 to avoid unnatural movement in heavy winds and are always used to secure the silhouette decoys to their motion top 10s.

Now referring to FIGS. 4A and 4B a top, bottom, and side views of the rubber-fastening washer used to secure decoys in high winds to the decoy motion top 10 is illustrated. The holes 6 in the rubber-fastening washer are to slide over the motion top 10 pins 2 to secure the decoy in heavy winds and to secure silhouette decoys to their motion tops 10 at all times.

The Field Decoy System consists of one to several decoy activation cords. Each activation cord will require two end stakes 7 & 11, one bungee cord 8 and one to several decoy motion stakes 10. The decoy motion stakes are driven into the ground where the hunter would like to have his decoys and represent motion in his/her decoys. One end stake 11 will be located near the hunter's blind or location and the other end stake will be located on the far side of the decoys to be controlled from the hunter's blind or location 7. The bungee cord 8 is attached to the far end stake 7 on the string hook 50. The decoy activation cord 9 is looped or tied to the free end of the bungee cord 8 opposite of the stake. For the shell/full body rotary top and the silhouette rotary top the decoy cord is wrapped around the pulley area 1, which is the means for the rotary motion, on each decoy stake 10 with slight tension on the bungee cord to keep everything tight.

The direction of the wrap on the decoy stake pulley area being clockwise or counter clockwise will dictate which direction the decoy will turn. Decoys that are wrapped clockwise will turn clockwise and decoys wrapped counter clockwise will also turn counter clockwise. It is possible to make some decoys turn clockwise and some decoys turn counter clockwise or all decoys turn the same direction on the same decoy activation string setup. The direction the decoys turn and which decoys turn in which direction is all up to the hunter and how they might want the decoys to operate. Stakes can be driven into the ground near the activation string for the two types of feeder tops. Then the string clip 36 is attached to the main activation cord. The string from the last decoy stake is pulled back and tied on to the string hook 50 on the end stake 11 near the hunter's blind or location while still under slight tension. This can be repeated over again until the end stakes can not hold any more strings or there becomes too many for the hunter to effectively control.

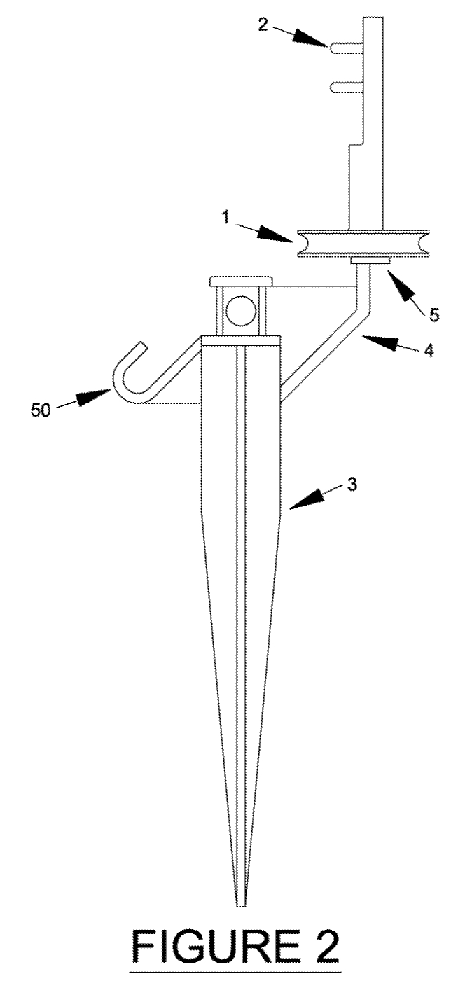

To operate the decoy system a hunter will just push the cord, at the stake, to the ground or pull on the cord. This causes the activation cord 9 to move and stretch the bungee cord 8 and as the string pulls toward the hunter, the decoy stakes motion top 10 rotates and the feeder tops tip forward and move the decoys on them to make motion in the decoys. The shell or full body decoys will just sit on the two pins 2 at the top of the stake to hold them and turn them. During high wind conditions the rubber-fastening washer, as shown in FIGS. 2A & 2B can be used over the pins to secure the decoy to the stake and avoid unnatural movement in heavy winds. The silhouette decoys will be mounted to their motion top 10 and secured at all times with the rubber-fastening washer 16 over the pins 2 on the motion top 10.

Now referring to FIG. 2, an assembled side view of the motion stake 3 and rotary motion top 10 to turn silhouette decoys is illustrated. The decoy support bar 4 is shown and partially concealed in the motion top 10 as the motion top 10 rest on the stop washer 5. The pulley area 1 where the activation cord will cause the motion top 10 to rotate is shown here.

The motion stake for the shell and full body decoys makes the decoys rotate back and forth and the feeder tops tip forward. This is a realistic motion that is same as birds in motion and feeding in a field and a very good motion system for making birds land in a hunter's decoys. The silhouette rotary top decoys stakes make a type of motion that is highly visible at farther distances than the other motion stake. If the silhouette decoys are started at a position facing directly toward the game animal to be attracted as the string is pulled the decoy rotates and after turning 90 degrees the completely disappear from sight. It is very typical for various silhouette motion stakes to have their silhouette decoys at various angles to the game to be attracted. As the string is moved and the decoys rotate and the different stakes disappear and reappear at different times than all the other stakes and gives a random and high visible motion in a decoy spread.

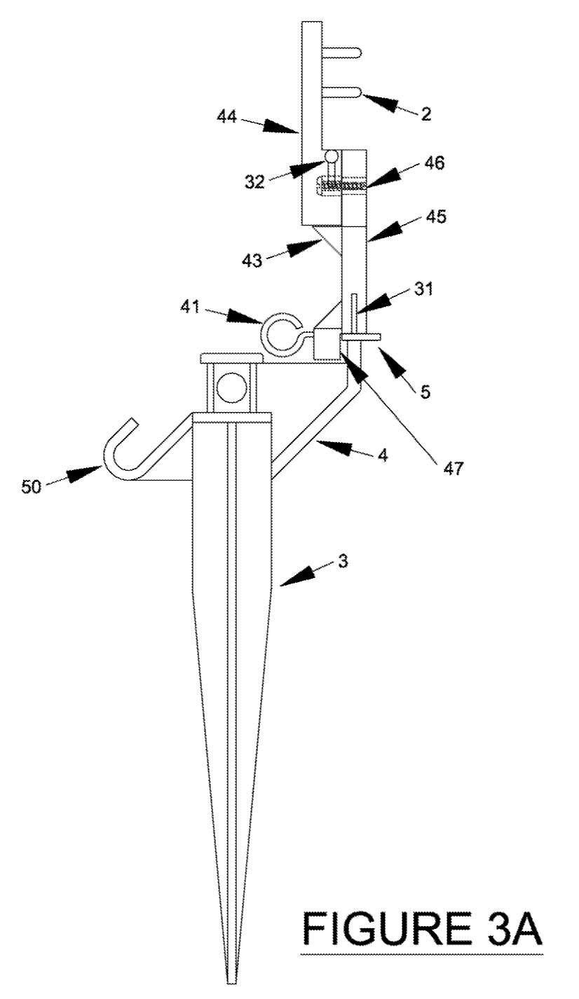

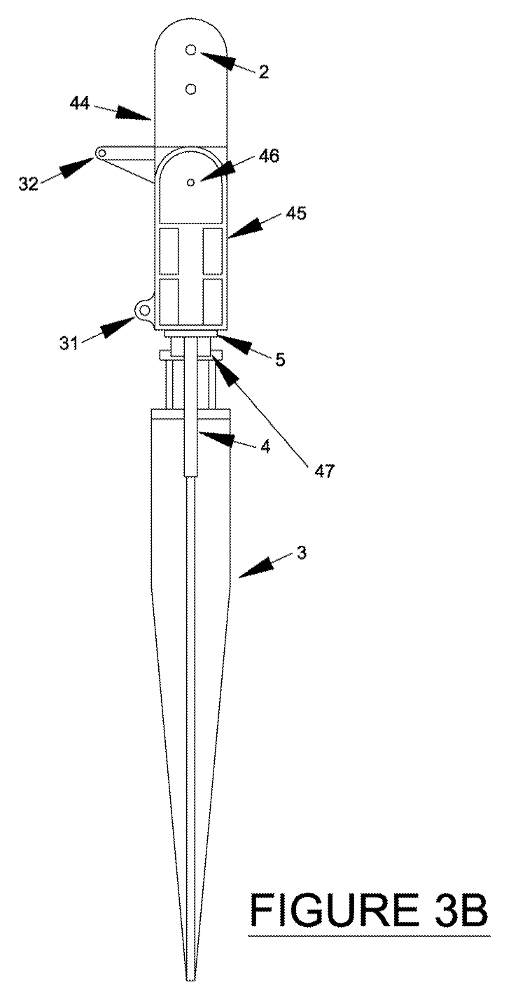

Now referring to FIGS. 3A, an assembled side view of the motion stake 3 with the silhouette feeding top is illustrated. The feeding top consisted of the top moving part 44 and the bottom stationary part 45. The motion top 10 assembly sits on the decoy support bar 4 and rest decoy support washer 5. The bottom part of the assembly has a motion stop key 47 that slides past the flat spot on the decoy support washer 5 and prevents the top from swiveling on the decoy support bar 4. The guide loop 41 keeps the activation cord near the motion top 10. The reverse motion stop 43 on the bottom part prevents the top part from traveling in a backward direction.

Now referring to FIGS. 3B, an assembled front view of the motion stake 3 with the silhouette feeding top is illustrated. The feeding top consisted of the top moving part 44 and the bottom stationary part 45. In this view the motion lever 32 that is pulled by the decoy specific activation cord through the string loop 31 is specifically illustrated.

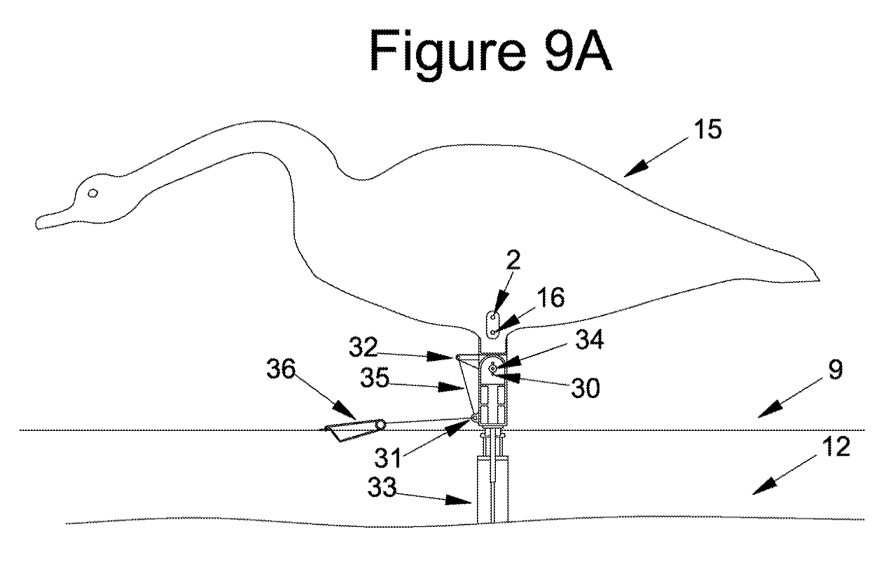

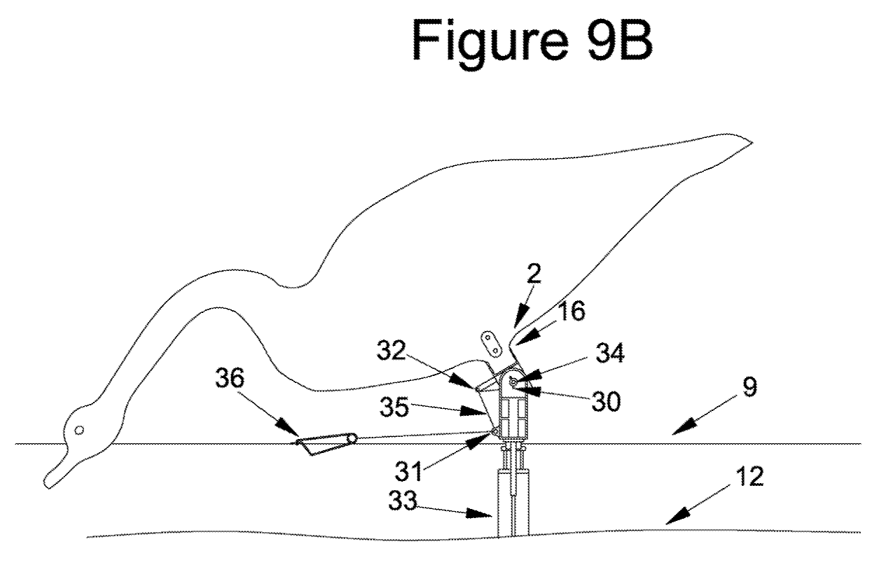

FIGS. 9A & 9B further illustrated the decoy specific activation cord. FIG. 9A illustrates an assembled front view of the motion stake and silhouette feeding motion top 10 to move silhouette decoys in a vertical feeding motion. The silhouette decoy 15 is mounted on the securing pins 2 of a decoy motion top 10. The main activation cord 9 is shown where it will pass the motion top 10. A decoy specific activation cord 35 connects to the motion lever 32 and travels trough the string loop 31 and connects to the main activation cord with the string clip 36. This decoy specific activation cord will provide the means for motion to the silhouette decoy as the main activation cord is moved. The relationship of the decoy stake to the ground 12 is also visible. In FIG. 9B the silhouette decoy is shown in the state it would be after the activation cord has moved and the decoy has rocked forward to appear that it was feeding. The silhouette decoy would pivot on the attachment area 34 of the two parts of the top.

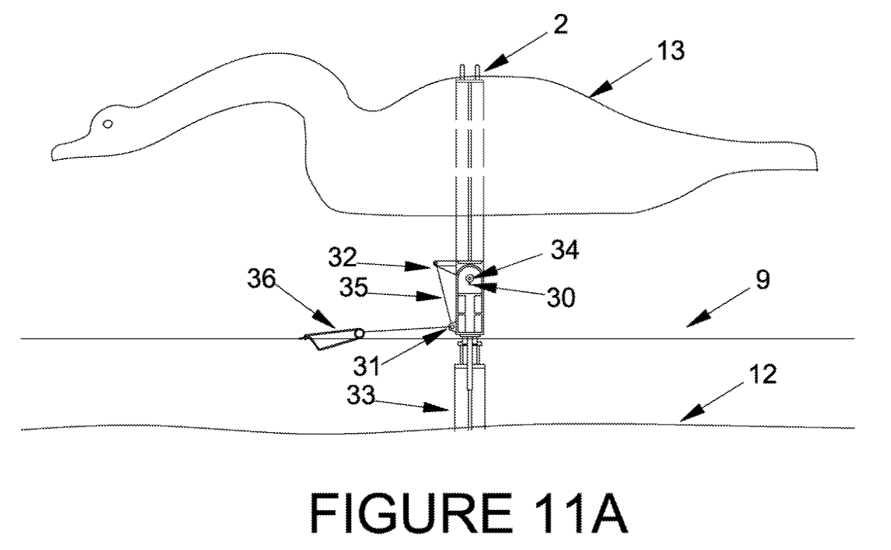

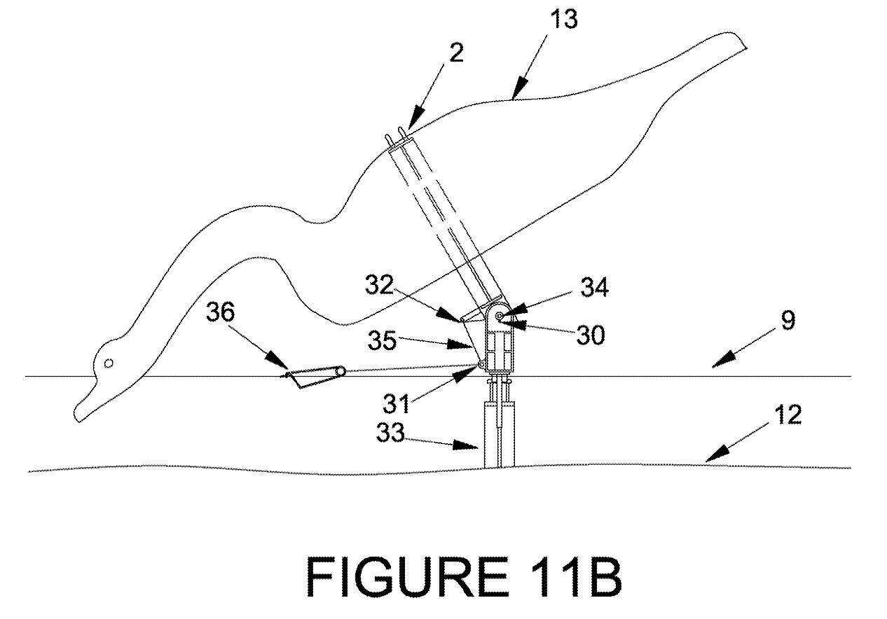

FIG. 5 illustrates a top view of the decoy system deployed with eight decoy stakes for shell or full body decoys and two activation cords. Decoys are not shown, as they would obscure the view of the stakes and activation cord connections. The arrows show the rotation of top attachment to the decoy stakes. The first stake 7 is used to anchor the activation cords and stretch cords 8. The activation cords 9 is attached to the stretch cord 8 and the activation cords are wrapped around each decoy motion stake 10 on the way back to the hunter's blind where it in secured to another stake 11 at the string hook 50 to ready the system for usage. These tops shown are only for the shell or full body tops. Silhouette top would replace them as they are and Feeder tops would also replace them and jut have the string clip 36 attach to the decoy activation cord 9. FIGS. 9A, 9B, 11A and 11B illustrate the feeder's top connection to the main activation cord.

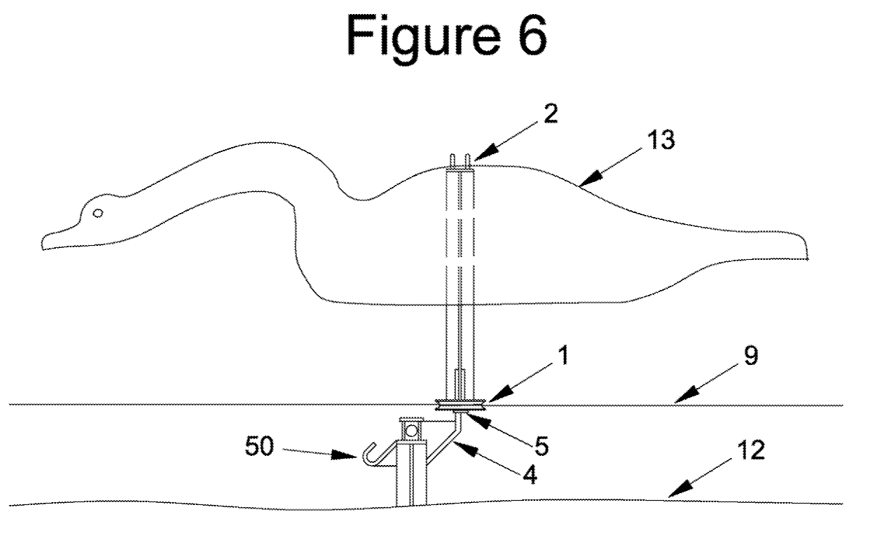

Now referring to FIG. 6, the side view of a shell decoy 13 mounted on the securing pins 2 of a Decoy Motion stake is shown. The activation cord 9 can be seen here where it connects to the motion top 10 to provide the means for motion. The relationship of the decoy stake to the ground 12 is also visible.

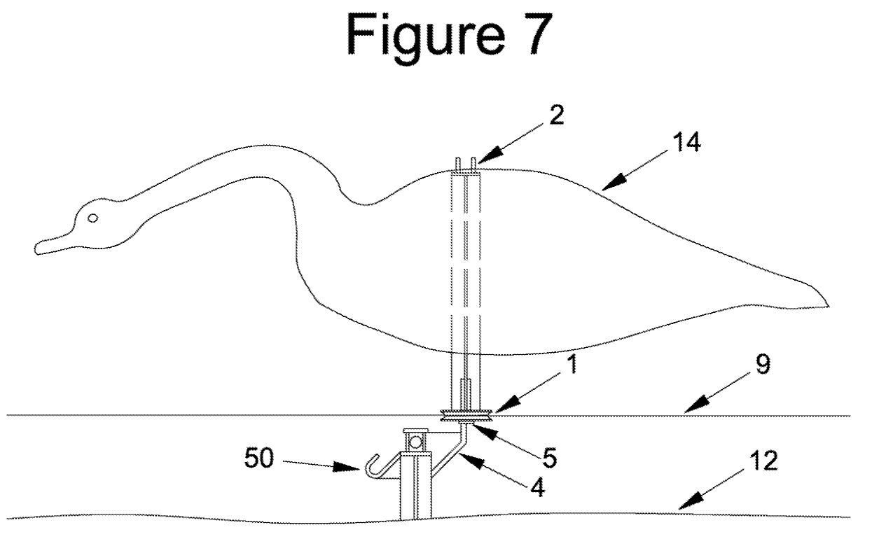

FIG. 7 shows the side view of a full body decoy 14 mounted on the securing pins 2 of a Decoy Motion stake. The activation cord 9 can be seen here where it connects to the motion top 10 to provide the means for motion. The relationship of the decoy stake to the ground 12 is also visible.

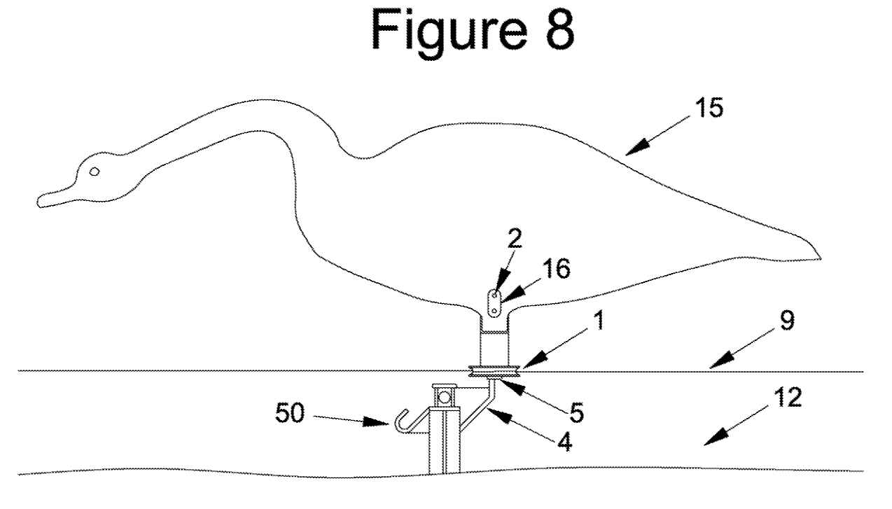

Now referring to FIG. 8, a completely assembled side view of the motion stake and rotary motion top 10 to turn silhouette decoys is illustrated. The decoy support bar 4 is shown and partially concealed in the motion top 10 as the motion top 10 rests on the stop washer 5.

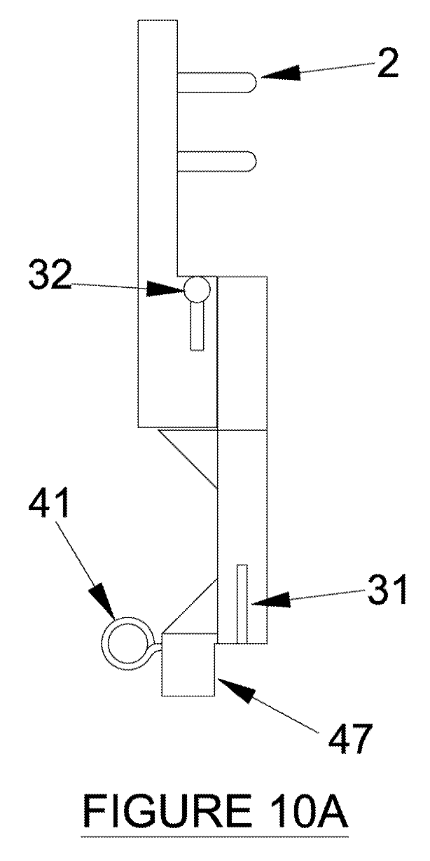

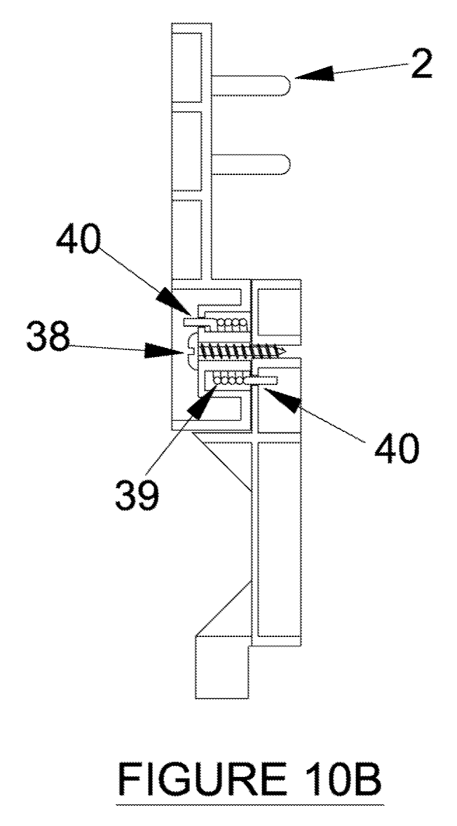

FIG. 10A shows the side view of the silhouette feeder top. The motion lever 32, the string loop 31, the main activation cord guide loop 41 and the top motion stop key 47 are easily seen. FIG. 10B is the same view as FIG. 10A except illustrating a cut away view. The view shows the relationship of the torsion spring 39, the joining screw 38 and the holes 40 for the torsion spring legs. By now seeing the torsion spring 39 and how it's legs are pinned in to holes in the two parts of the motion top 10. As the motion top 10 rotates on the pivot point 38 it will apply tension to the part and return it to normal when the activation cord is returned to normal.

FIG. 11A illustrates a completely assembled front view of the motion stake and shell or full body feeding motion top 10 to move shell or full body decoys in a vertical feeding motion. The shell or full body decoy 13 will slide over the securing pins 2 of the decoy motion top 10. The main activation cord 9 can be seen here where it will pass the motion top 10. A decoy specific activation cord 35 will connect to the motion lever 32 and travel trough the string loop 31 and connect to the main activation cord with the string clip 36. This decoy specific activation cord will provide the means for motion to the shell or full body decoy. The relationship of the decoy stake to the ground 12 is also visible.

FIG. 11B shows the shell or full body decoy in the state it would be after the activation cord has moved and the decoy has rocked forward to appear that it was feeding. The shell or full body decoy would pivot on the attachment area 34 of the two parts of the top.

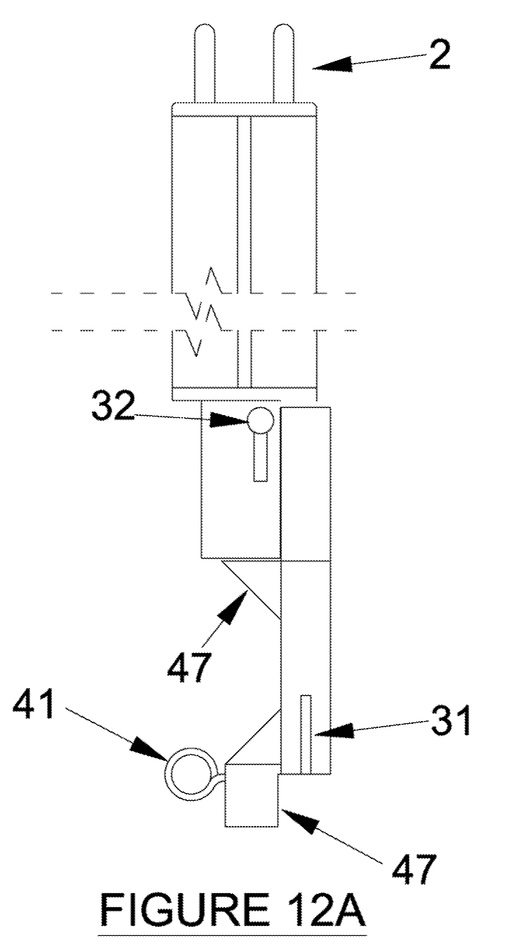

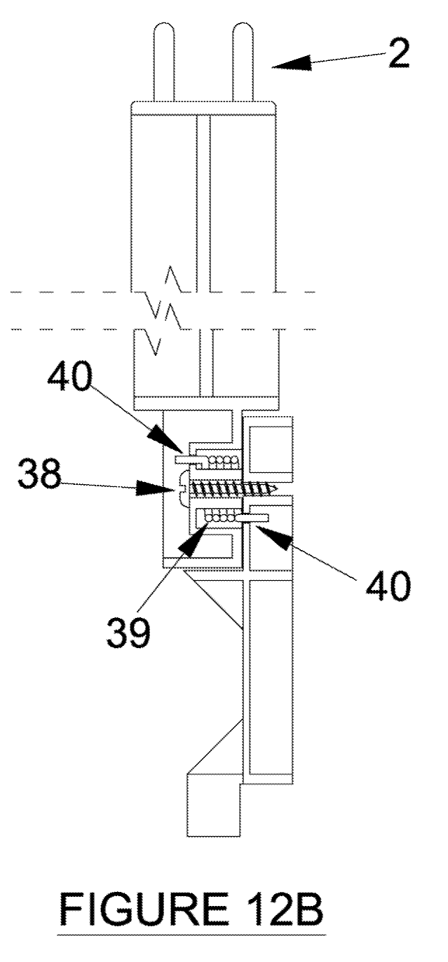

FIGS. 12A and 12B show the side view of the shell or full body feeder top. The motion lever 32, the string loop 31, the main activation cord guide loop 41 and the top motion stop 37 are easily seen. These figures illustrate the relation ship of the torsion spring 39, the joining screw 38 and the holes 40 for the torsion spring legs. The torsion spring 39 and its legs are pinned in to holes in the two parts of the motion top 10. As the motion top 10 rotates on the pivot point 38 it will apply tension to the part and return it to normal when the activation cord is returned to normal.

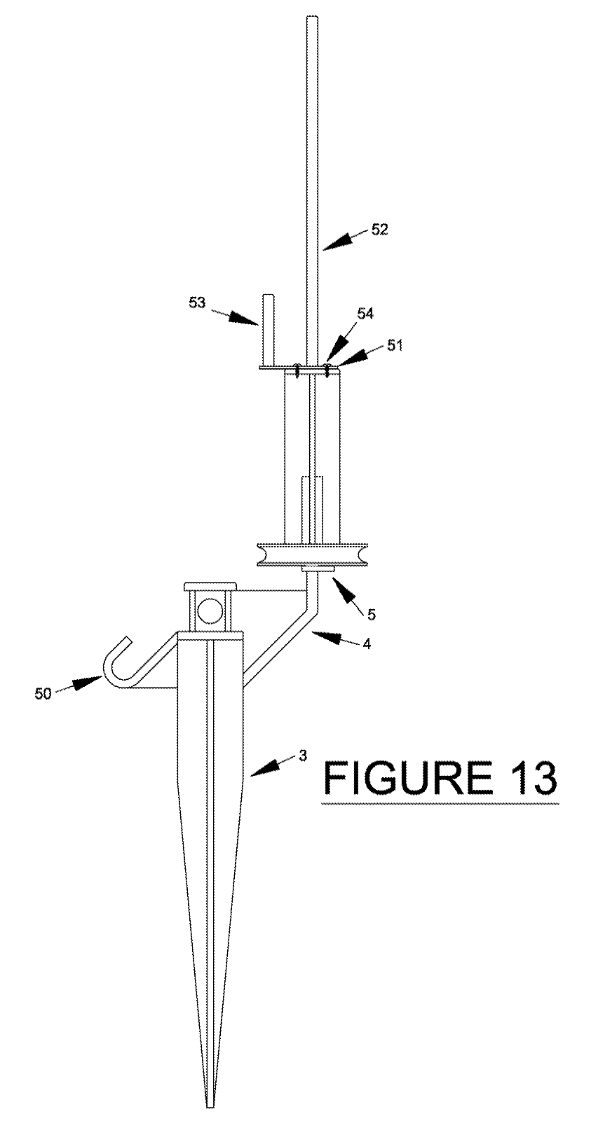

Now referring to FIG. 13 a completely assembled side view of the motion stake 3 and rotary motion top 10 to turn “specific” full body decoys is illustrated. The decoy support bar 4 is shown and partially concealed in the motion top 10 as the motion top 10 rests on the stop washer 5. The pulley area 1 where the activation cord will cause the motion top 10 to rotate is shown here. A top the motion top 10 is mounted the decoy control rods 52 & 53. Both rods are attached to the base plate 51 and screwed 54 to the motion top 10.

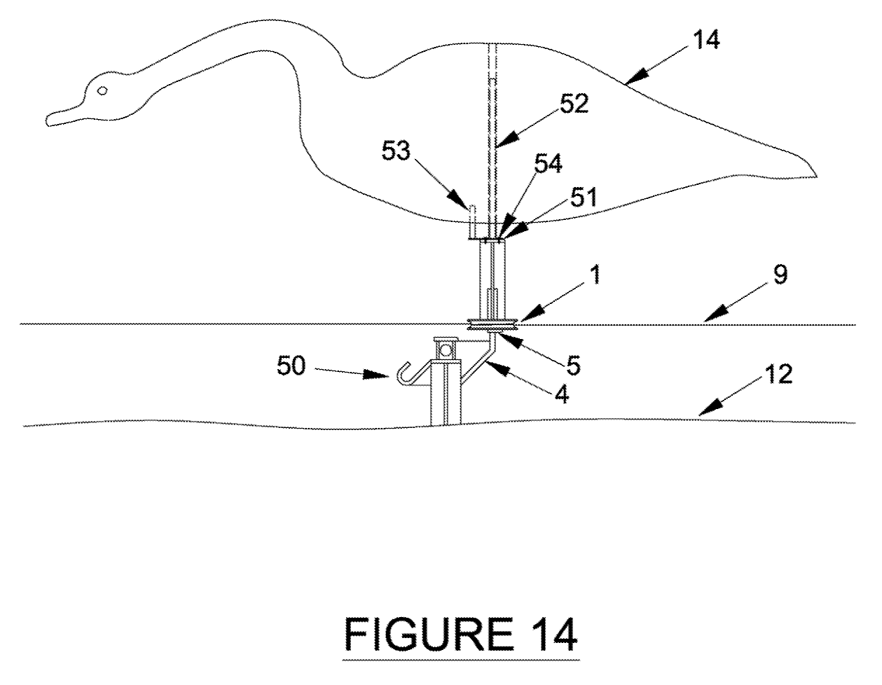

Finally, FIG. 14 shows the “specific” decoy mounted on the motion top 10 to control and rotate the “specific” decoy. One of the decoy control rods 52 slides up into the decoy cavity used to support the decoy. The other decoy control rod will be inserted on to a hole in the bottom of the decoy. Both rods are attached to the base plate 51 and screwed 54 to the motion top 10.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A decoy assembly comprising:
a stake, said stake further consisting of:
a nail head for driving the stake into the ground and removing the stake without damaging a motion top;
an upright post to allow the motion top to rotate;
a ledge to allow the motion top to rest; and
vanes to prevent unnecessary movement from said stake from wind and activation string forces.
a motion top, said motion top further consisting of
a means for supplying motion to a decoy from an activation cord;
a set of pins for securing the decoy and forcing the decoy to turn with the motion top in a clockwise or counter clockwise direction depending on the direction the activation cord is wrapped;
a stop washer providing resting means for the decoy and a rubber-fastening washer slide over the motion top providing means to secure the decoy to the stake over the pins;
an activation cord; and
a pulley providing means for the activation cord to cause the motion top to rotate.

2. The decoy assembly of claim 1 wherein:
the stake is pushed in to the ground;
the motion top is attached to the stake and resting on the ledge and held in place by the upright post; and
the activation cord is then attached to the motion top by the means for transmitting its energy to make the motion top and the decoy rotate.

3. The decoy assembly of claim 2 wherein the stake, in combination with the activation cord, provides means for transmitting rotary energy into said stake and to a decoy on said stake from the linear energy of said activation cord.

4. The decoy assembly of claim 1 further comprising a decoy stake with means for transferring a rotary motion to a shell decoy, full body decoy, or silhouette decoy from the activation cord.

5. The decoy assembly of claim 1 wherein:
the activation cord is connected to an end stake at a hunter's location and then runs to one or more decoy motion stakes;
the activation cord is connected to a bungee cord and another end stake on an opposing side of the decoys from the hunter's location; and
a string hook that ties off the activation cord and secures the bungee cord to end stakes.

6. The decoy assembly of claim 4 wherein the shell decoys further consists of two holes at the decoy balance point that are three-quarters of an inch on center from each other.

7. The decoy assembly of claim 4 wherein the full body decoys further consists of two holes at the decoy balance point that are three-quarters of an inch on center from each other and a larger hole in the bottom of the full body decoy.

8. The decoy assembly of claim 4 wherein the Silhouette decoys further consists of two holes three-quarters of an inch on center to support and control the decoys;
said two holes are located near the base of the silhouette decoys so they can be attached to their motion tops; and
said holes allow the decoy to slide on to the motion top and be rotated or tipped forward into a feeding motion depending on the motion top.

9. The decoy assembly in any one of claims 6, 7, or 8 wherein the decoy further consists of;
a hole drilled one inch from the center of the existing decoy support tube; and wherein
the decoy rests and is supported by a decoy control rod and is controlled and rotated by a decoy support bar.

10. The decoy assembly of claim 1 wherein
the assembly consists of one or more decoy activation cords;
each activation cord requires two end stakes, one bungee cord and one or more decoy motion stakes;
the decoy motion stakes are driven into the ground in a desired location;
one end stake is located near the hunter's location and the other end stake is located on the opposite side of the decoys to be controlled from the hunter's blind location; and
the bungee cord is attached to the far end stake on a string hook.

11. The decoy assembly of claim 10 wherein for the shell/full body rotary top and the silhouette rotary top, the decoy cord is wrapped around the pulley area on each decoy stake with slight tension on the bungee cord providing continuous tension, providing means for the rotary motion.

12. The decoy assembly of claim 10 wherein;
the decoy activation cord is attached to the free end of the bungee cord opposite of the stake;
the direction of the wrap on the decoy stake pulley area is clockwise or counter clockwise will dictate which direction the decoy will turn; and
decoys that are wrapped clockwise will turn clockwise and decoys wrapped counter clockwise will also turn counter clockwise.

13. The decoy assembly of claim 10 wherein;
a plurality of stakes are driven into the ground near the activation string for one or more types of feeder tops;
a string clip is attached to the main activation cord;
a string from the last decoy stake is pulled back and tied on to the string hook on the end stake near the hunter's location while under tension.

14. The decoy assembly of claim 4 wherein;
the silhouette feeding top consists of a top moving part and the bottom stationary part;
the motion top assembly sits on a decoy support bar and a rest decoy support washer; the bottom part of the assembly has a motion stop key that slides past the flat spot on the decoy support washer and prevents the top from swiveling on the decoy support bar;
a guide loop keeps the activation cord near the motion top; and
a reverse motion stop on the bottom part prevents the top part from traveling in a backward direction.

15. The decoy assembly of claim 1 wherein;
a first stake is used to anchor the activation cords and stretch cords;
said activation cords are attached to a stretch cord and the activation cords are wrapped around each decoy motion stake on the way back to the hunter's location where they are secured to a second stake 11 at the string hook.

16. The decoy assembly of claim 1 wherein Feeder tops have a string clip attached to the decoy activation cord.

17. The decoy assembly of claim 4 wherein the silhouette feeder tops further comprising:
a motion lever,
a string loop,
a main activation cord guide loop;
a top motion stop key;
a torsion spring;
the joining screw; and
holes for the torsion spring legs pinned in to said holes in the motion top.

18. The decoy assembly of claim 4 wherein the shell or full body feeder tops further comprising:
a motion lever;
a string loop;
a main activation cord guide loop;
a top motion stop;
a torsion spring;
joining screw; and
holes for the torsion spring legs, said torsion spring and its legs are pinned in to the holes in the motion top.
